(19) United States
(12) Patent Application Publication
(10) Pub. No.: US 2015/0314464 A1
(43) Pub. Date: Nov. 5, 2015

(54) SHAVING SYSTEM

(71) Applicant: John Wayne Guzak, Midlothian, VA (US)

(72) Inventor: John Wayne Guzak, Midlothian, VA (US)

(21) Appl. No.: 14/699,801

(22) Filed: Apr. 29, 2015

Related U.S. Application Data
(60) Provisional application No. 62/047,794, filed on Sep. 9, 2014.
(60) Provisional application No. 61/986,258, filed on Apr. 30, 2014.

(51) Int. Cl. B26B 21/44; B26B 21/52

(52) U.S. Cl. CPC B26B 21/443; B26B 21/521

(57) ABSTRACT

An advantageous combination of a novel shaving medium dispenser and a novel shaving razor is provided. The dispenser may be made of ferromagnetic material configured in a generally cylindrical, cuboid, or trapezoidal prism shape. A mirror may be disposed near a lower portion of the dispenser's shape. Along the lower portion and an upper portion of the dispenser, two complementary flat surfaces for supporting itself in a prone orientation may be disposed. One or both of the upper and lower portions may provide a cradle for removably securing a head portion of the shaving razor. The shaving razor may also provide a magnetized handle portion and a styptic portion thereon.

### CROSS-REFERENCE TO RELATED APPLICATION

This application claims the benefit of priority of U.S. provisional application No. 62/047,794, filed 9 Sep. 2014, and U.S. provisional application No. 61/986,258, filed 30 Apr. 2014, the contents of which are herein incorporated by reference.

### BACKGROUND OF THE INVENTION

The present invention relates to hair removing systems and, more particularly, to a system that advantageously embodies the novel combination of a shaving cream dispenser and a shaving razor.

People who wet shave have to overcome some inherent disadvantages of the current systems: if they cut themselves shaving, they need to use a separate component to stop the bleeding, such as a styptic or toilet paper; they must store and find their shaving razors in locations separate from the shaving cream dispenser, inviting safety hazards involving the loose razors, such as in a travel bag; if they need a mirror, they need a separate component; and if they use a metal-based shaving cream dispenser, such dispenser cans may form rust rings when placed in moist locations.

As can be seen, there is a need for a system that advantageously embodies a novel combination of a shaving cream dispenser and a shaving razor.

### SUMMARY OF THE INVENTION

In one aspect of the present invention, a shaving razor provides a head portion generally perpendicularly joined to a handle portion, wherein the handle portion is magnetized.

In another aspect of the present invention, a shaving dispenser provides a receptacle having a ferromagnetic material forming a compartment for receiving a shaving medium; two dispenser rings, each dispenser ring dimensioned and adapted to secure to opposing ends of the receptacle, wherein each dispenser ring forms a plurality of flat surfaces along a periphery thereof, each flat surface having a complementary flat surface on the opposing dispenser ring; and a razor head cradle disposed along at least one dispenser ring.

In yet another aspect of the present invention, a shaving system provides a shaving dispenser having a receptacle comprising a ferromagnetic material forming a compartment for receiving a shaving medium; and two dispenser rings, each dispenser ring dimensioned and adapted to secure to the opposing ends of the receptacle, wherein each dispenser ring forms a plurality of flat surfaces along a periphery thereof, each flat surface having a complementary flat surface on the opposing dispenser ring; and a shaving razor having a head portion dimensioned and adapted to removably secure to the razor head cradle; and a handle portion generally perpendicularly joined to the head portion, wherein the handle portion is magnetized.

In yet another aspect of the present invention, a shaving system provides a shaving dispenser having a receptacle comprising a ferromagnetic material forming a compartment for receiving a shaving medium; a top portion and a bottom portion of said receptacle forming a plurality of flat surfaces along a periphery thereof, each flat surface having a complementary flat surface on the opposing dispenser portion; and a shaving razor having a head portion dimensioned and adapted to removably secure to the razor head cradle; and a handle portion generally perpendicularly joined to the head portion, wherein the handle portion is magnetized.

These and other features, aspects and advantages of the present invention will become better understood with reference to the following drawings, description and claims.

### BRIEF DESCRIPTION OF THE DRAWINGS

FIG. 1 is a perspective view of an exemplary embodiment of the present invention;

FIG. 2 is an exploded view of an exemplary embodiment of the present invention;

FIG. 3 is a section view of an exemplary embodiment of the present invention, taken along line 3-3 in FIG. 1;

FIG. 4 is a perspective view of an exemplary embodiment of the present invention;

FIG. 5 is an exploded view of an exemplary embodiment of the present invention;

FIG. 6 is a section view of an exemplary embodiment of the present invention, taken along line 6-6 in FIG. 4;

FIG. 7 is a perspective view of an exemplary embodiment of the present invention;

FIG. 8 is an exploded view of an exemplary embodiment of the present invention;

FIG. 9 is a perspective view of an exemplary embodiment of the present invention; and

FIG. 10 is an exploded view of an exemplary embodiment of the present invention.

### DETAILED DESCRIPTION OF THE INVENTION

The following detailed description is of the best currently contemplated modes of carrying out exemplary embodiments of the invention. The description is not to be taken in a limiting sense, but is made merely for the purpose of illustrating the general principles of the invention, since the scope of the invention is best defined by the appended claims.

Broadly, an embodiment of the present invention provides an advantageous combination of a novel shaving medium dispenser and a novel shaving razor. The dispenser may be made of ferromagnetic material configured in a generally cylindrical, cuboid, or trapezoidal prism shape. A mirror may be disposed near a lower portion of the dispenser's shape. Along the lower portion and an upper portion of the dispenser, two complementary flat surfaces for supporting itself in a prone orientation, or in an upward tilting orientation may be disposed. One or both of the upper and lower portions may provide a cradle for removably securing a head portion of the shaving razor. The shaving razor may also provide a magnetized handle portion and a styptic portion thereon.

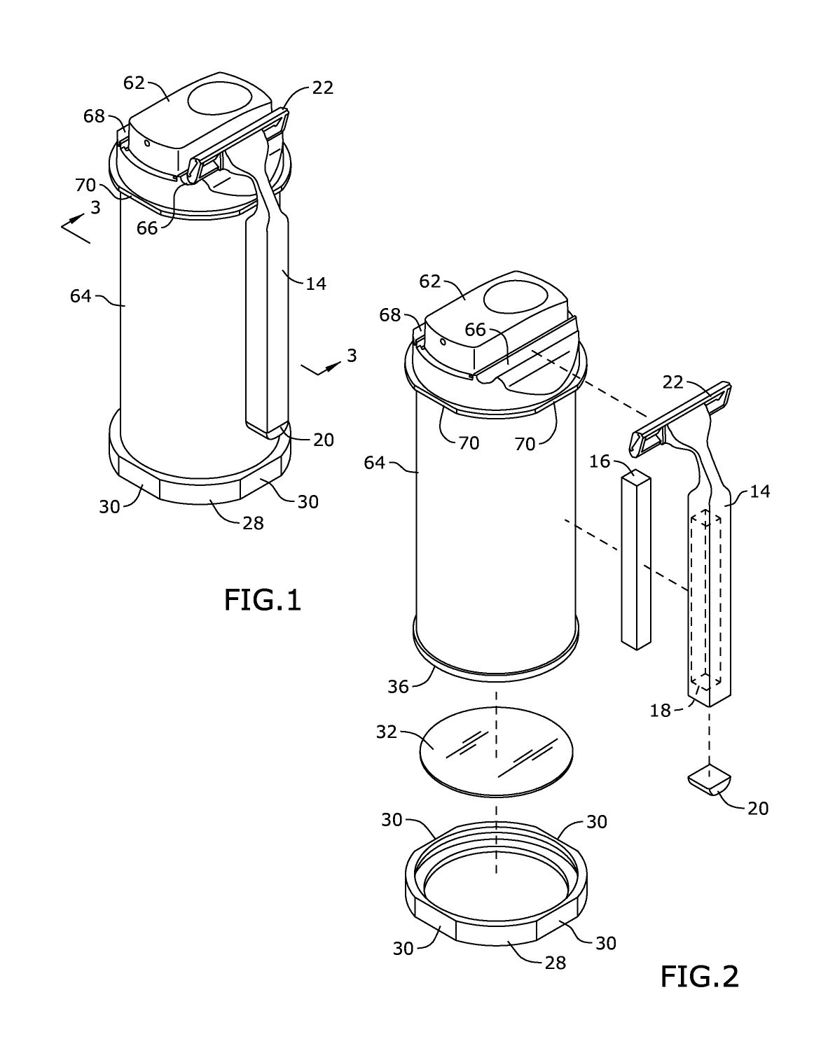

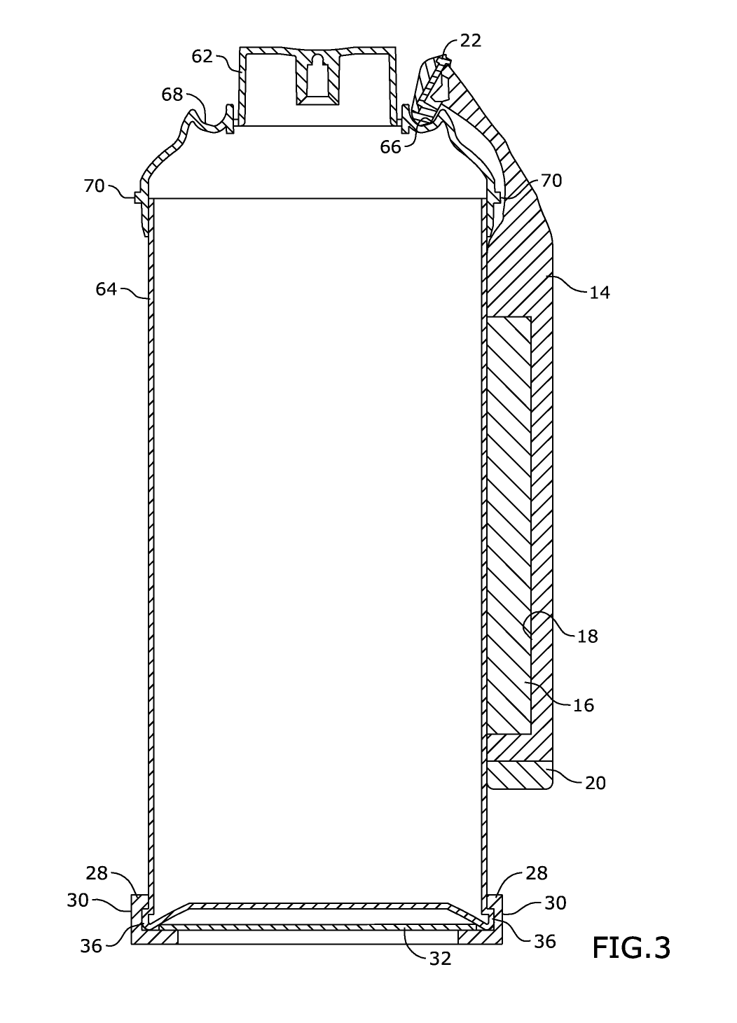

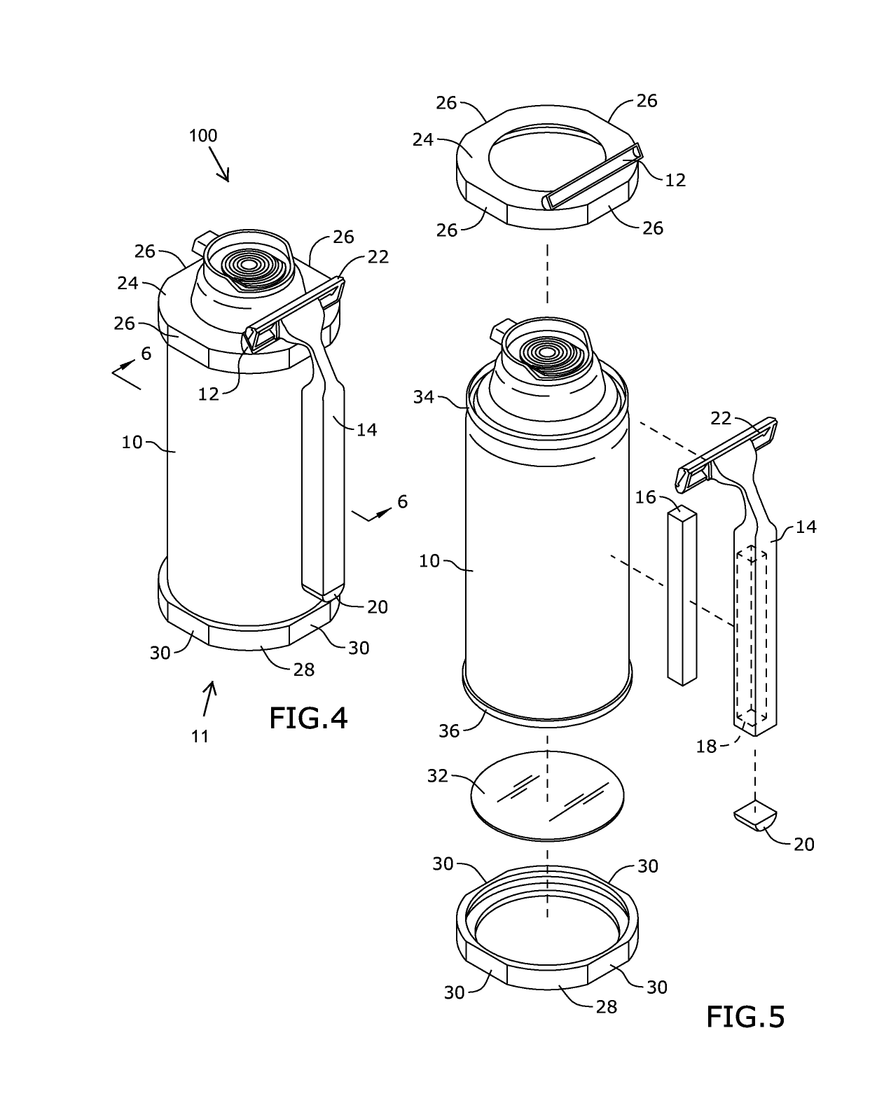

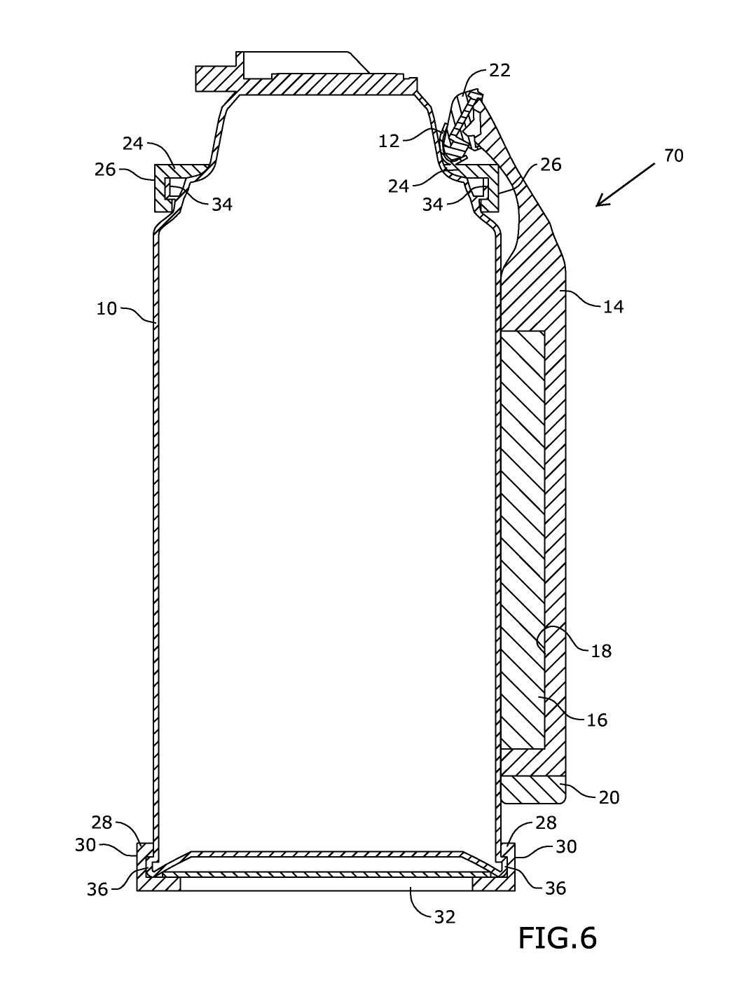

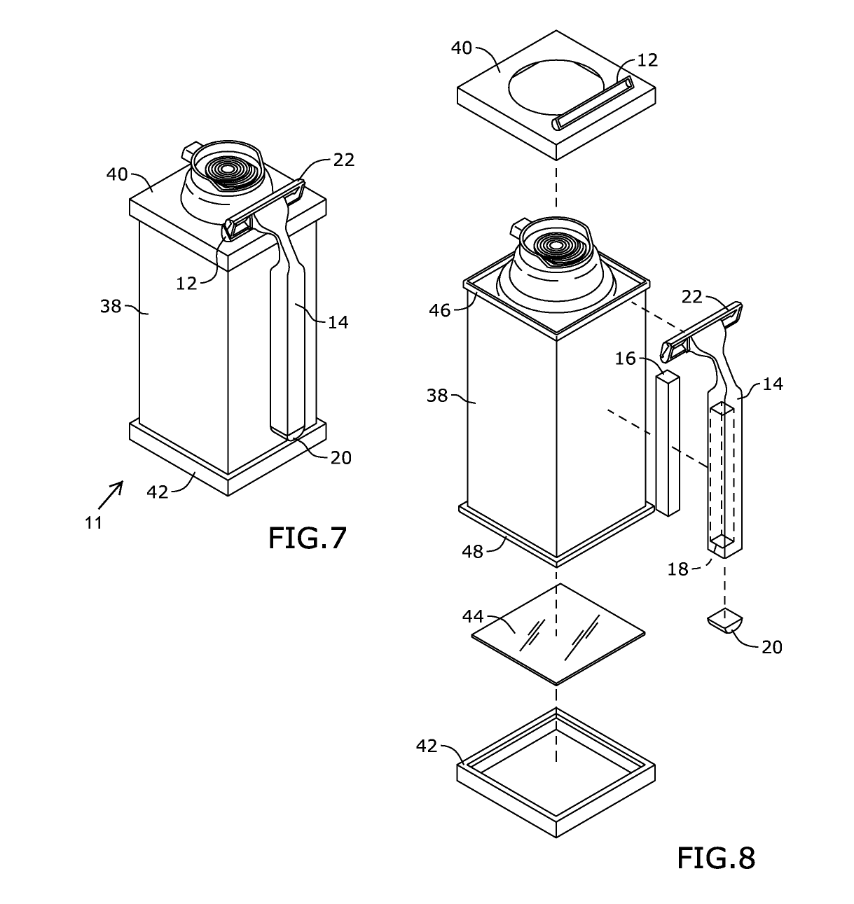

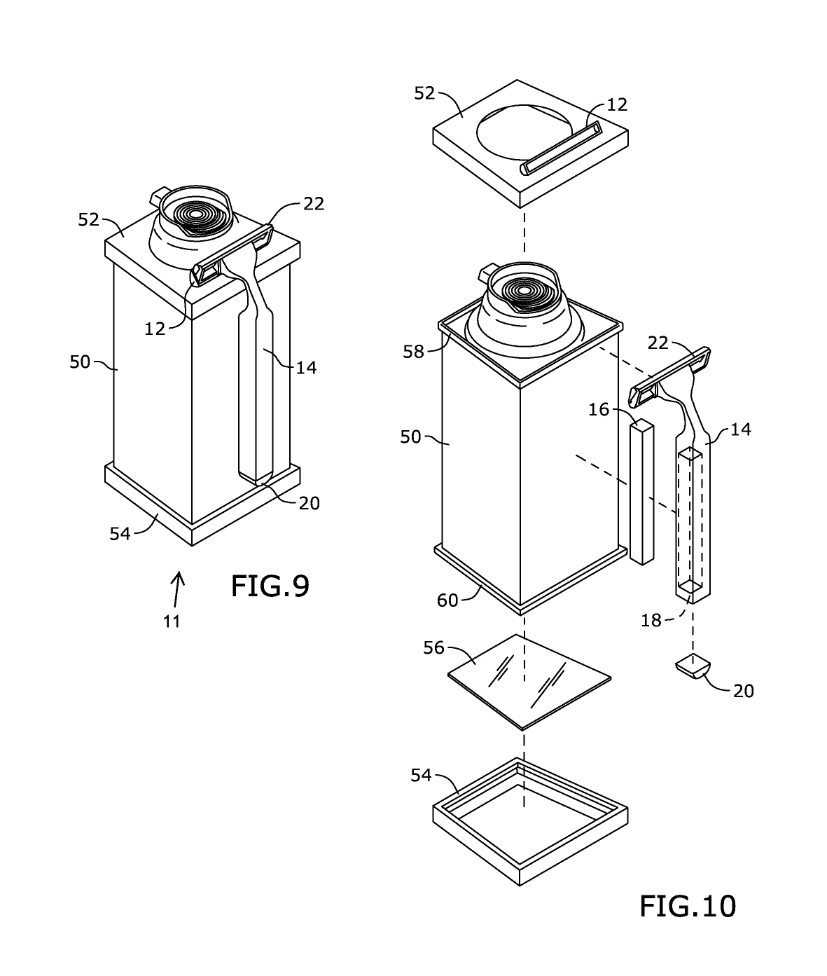

Referring to FIGS. 1 through 10, the present invention provides a shaving system 100 that advantageously embodies a novel combination of a shaving cream dispenser 11 and a shaving razor 70.

The dispenser 11 may include a receptacle 10, 38, 50 forming a compartment for receiving a shaving medium, including but not limited to foam, gel and other forms of shaving cream. The dispenser 11 may provide a nozzle adapted to dispensing the shaving medium from the receptacle 10, 38, 50 by engaging a nozzle trigger. The nozzle and the nozzle trigger may be provided by a dispenser cap 80, wherein the dispenser cap 80 may be dimensioned and adapted to seal an upper portion of the receptacle 10, 38, 50.

The receptacle 10, 38, 50 may be made of ferromagnetic material configured in any geometric shape, including but not limited to generally cylindrical 10, cuboid 38, trapezoidal prism 50, and the like, so long as the dispenser 11 functions in accordance with the present invention as described herein. Specifically, in certain embodiments, the overall volume of the receptacle 10, 38, 50 may be dimensioned and adapted to store a month's supply of the shaving medium, thereby matching the functional life of the shaving razor. Specifically, in certain embodiments, the overall length of the dispenser 11 may be dimensioned and adapted to fit in standard medical cabinets.

A longitudinal periphery of the receptacle 10, 38, 50 may terminate in two opposing, bookending upper and lower lips 34/36, 46/48, and 58/60, respectfully.

The dispenser 11 may include a lower dispenser ring 28, 42, 54 and an upper dispenser ring 24, 40, 52, each ring being dimensioned and adapted to removably secure to their respective upper and lower lips 34/36, 46/48, and 58/60, so as to prevent rust rings from forming at the can/lip joints. Each upper dispenser ring 24, 40, 52 may form a nozzle aperture for accommodating the nozzle of the dispenser 11. Each lower dispenser ring 28, 42, 54 may form a mirror aperture. Each ring 28, 42, 54, 24, 40, 52 may form a plurality of upper flat edges 26 and lower flat edges 30 along its respective periphery. Each upper flat edge 26 may have a complimentary, planar lower flat edge 30 so that the dispenser 11 may thereby be supported on a flat surface, such that the longitudinal axis of the receptacle 10, 38, 50 may be in a generally parallel orientation thereto (a “prone orientation”).

The lower lip 36, 48, 60 may be dimensioned and adapted to secure a suitably shaped mirror 32, 44, 56, respectively, along a mirror periphery. Each mirror 32, 44, 56 may be sandwiched, along a portion of its mirror periphery, between the lower lip 36, 48, 60 and the lower ring 28, 42, 54, so that the mirror 32, 44, 56 is substantially viewable through the mirror aperture.

The dispenser 11 may include a head cradle 12 disposed on either or both of the upper 24, 40, 52 and the lower 28, 42, 54 dispenser rings. Each head cradle 12 may be dimensioned and adapted to removably secure a head portion 22 of the novel shaving razor 70 thereto.

In certain embodiments, each upper dispenser ring 24, 40, 52 and lower dispenser ring 28, 42, 54 may be integrally joined to the dispenser cap 80 and the bottom of the shaving dispenser 11, respectively, as illustrated in FIG. 1, so as to preclude the nozzle aperture. As a result, the dispenser cap 80 may provide at least the nozzle, the nozzle trigger, the relevant upper dispenser ring 24, 40, 52 and the head cradle 12.

The novel shaving razor 70 may include a handle portion 14 generally perpendicularly joined to the head portion 22. The handle portion 14 may form a cavity 18 for securing a magnet 16 therein. In certain embodiments, the handle portion 14 may be made of a magnetic material. In an alternative embodiment, the handle portion 14 may be magnetized.

A styptic portion 20 may be disposed along the handle portion 14. In certain embodiments, the styptic portion 20 may be disposed at an end of the handle portion 14 that opposes the head portion 22. The styptic portion 20 may provide any antihemorrhagic agent or the like adapted to stop the bleeding of shaving cuts.

The method of using the present invention may include the following. The shaving system 100 disclosed above may be provided. When not in use, a user may set the head portion 22 of the shaving razor 70 in the head cradle 12 so as to magnetically engage the handle portion 14 along the length of the receptacle 10, 38, 50.

When in use, the user may remove the shaving razor 70 from the head cradle 12, disengaging the handle portion 14 from alongside the receptacle 10, 38, 50, and maneuver the dispenser 11 so as to use the mirror 32, 44, 56 when shaving. If the user cuts oneself, they may employ the styptic portion 20 to such a cut.

Subsequent use, the user may place the dispenser 11 on a flat surface, either in an upright orientation by using the support of the relevant lower ring 28, 42, 54, or in the prone orientation by using the support of the complementary, planar flat edges 26, 30.

Campers, outdoorsy, and military types will find the totality of the system convenient to use, as will all other users.

It should be understood, of course, that the foregoing relates to exemplary embodiments of the invention and that modifications may be made without departing from the spirit and scope of the invention as set forth in the following claims.

What is claimed is:

1. A shaving razor, comprising:
a head portion generally perpendicularly joined to a handle portion, wherein the handle portion is magnetized.

2. The shaving razor of claim 1, further comprising a styptic portion disposed on the handle portion.

3. The shaving razor of claim 1, wherein the handle portion comprises a magnetic material.

4. The shaving razor of claim 1, wherein a magnetic cavity is formed within the handle portion.

5. The shaving razor of claim 3, further comprising a magnet in the magnetic cavity.

6. A shaving dispenser, comprising:
a receptacle comprising a ferromagnetic material forming a compartment for receiving a shaving medium;
two dispenser rings, each dispenser ring dimensioned and adapted to secure to opposing ends of the receptacle, wherein each dispenser ring forms a plurality of flat surfaces along a periphery thereof, each flat surface having a complementary flat surface on the opposing dispenser ring; and
a razor head cradle disposed along at least one dispenser ring.

7. The shaving dispenser of claim 6, further comprising a dispenser cap, wherein one dispenser ring is integrally joined to the dispenser cap.

8. The shaving dispenser of claim 7, wherein the other dispenser ring is integrally joined to the bottom of the shaving dispenser.

9. The shaving dispenser of claim 6, further comprising a mirror having a periphery, wherein a portion of the periphery is sandwiched by one of the dispenser rings and a lower portion of the receptacle.

10. The shaving dispenser of claim 6, wherein the receptacle is generally a trapezoidal prism.

11. The shaving dispenser of claim 6, wherein the receptacle is generally a cuboid.

12. The shaving dispenser of claim 6, wherein the receptacle is cylindrical.

13. A shaving system, comprising:
a shaving dispenser comprising:
a receptacle comprising a ferromagnetic material forming a compartment for receiving a shaving medium; and
two dispenser rings, each dispenser ring dimensioned and adapted to secure to the opposing ends of the receptacle, wherein each dispenser ring forms a plurality of flat surfaces along a periphery thereof, each flat surface having a complementary flat surface on the opposing dispenser ring; and
a shaving razor comprising:
a head portion dimensioned and adapted to removably secure to the razor head cradle; and
a handle portion generally perpendicularly joined to the head portion, wherein the handle portion is magnetized.

14. The shaving system of claim 13, further comprising a styptic portion disposed on the handle portion.

15. The shaving system of claim 13, further comprising a dispenser cap, wherein one dispenser ring is integrally joined to the dispenser cap.

16. The shaving system of claim 13, a razor head cradle disposed along at least one dispenser ring.

17. The shaving system of claim 13, further comprising a mirror having a periphery, wherein a portion of the periphery is sandwiched by one of the dispenser rings and a lower portion of the receptacle.
